(19) United States
(12) Patent Application Publication
(10) Pub. No.: US 2009/0313775 A1
(43) Pub. Date: Dec. 24, 2009

(54) GRAINS-REMOVING DEVICE FOR A LAUTER TUN

(75) Inventors: Ludwig Scheller, Ettringen (DE); Patrick Bahns, Kitzingen (DE); Josef Makowski, Kitzingen (DE); Georg Ziegler, Kitzingen (DE); Stephan Bauer, Ochsenfurt (DE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: GEA Brewery Systems GmbH, Kitzingen (DE)

(21) Appl. No.: 12/474,669

(22) Filed: May 29, 2009

(30) Foreign Application Priority Data
Jun. 19, 2008 (DE) 10 2008 028 867.5

(51) Int. Cl. C12C 7/17; B08B 9/087

(52) U.S. Cl. 15/57; 99/278

(57) ABSTRACT

The invention relates to a grains-removing device for a lauter tun on which at least one grains-removing member is provided which can be adjusted between a raised neutral position and a lowered grains-removing position, wherein the spent grains can be conveyed out of the lauter tun by rotationally driving the grains-removing member arranged in the grains-removing position, and wherein on the grains-removing device, at least one position sensor (01) is provided, by means of which the position of the grains-removing member can be detected in at least one position, wherein the position sensor (01) interacts with a transmitter unit, wherein the sensor data of the position sensor (01) for the description of the position of the grains-removing member can be transmitted in a wireless manner from the transmitter unit to a stationary mounted receiver unit and transferred from the receiver unit to a control unit, and wherein for the supply of electrical energy to the transmitter unit, an electro-mechanical generator unit is provided, wherein with the generator unit, mechanical drive movements can be transformed into electrical supply power, and wherein by means of a transmission device, the adjusting movements of the grains-removing device can be transmitted as drive movements directly or indirectly to the generator unit.

The invention relates to a grains-removing device for a lauter tun according to the preamble of claim 1.

During running off the wort during the beer production, at the bottom of the lauter tun, a cake of spent grains is formed, which serves as a filter layer. Upon completion of the running off process, the cake of spent grains must be removed from the lauter tun. For removing the cake of spent grains from the lauter tun, grains-removing devices are used. In these grains-removing devices, at least one grains-removing member is provided, which can be adjusted between a raised neutral position and a lowered grains-removing position. Moreover, the grains-removing member can be rotationally driven so that in the grains-removing position of the grains-removing member, the cake of spent grains can be conveyed out of the lauter tun.

For reaching of the grains-removing position, the grains-removing member is lowered to the surface of the false bottom of the lauter tun so that the cake of spent grains, during grains-removing, can be completely pushed off from the false bottom of the lauter tun. As soon as the grains-removing member is moved back into the neutral position, there is a sufficiently wide distance between the cake of spent grains and the grains-removing member so that the running off is not disturbed by the grains-removing member. For adjusting the grains-removing member between the neutral position and the grains-removing position, or between the grains-removing position and the neutral position, respectively, significantly different drive units can be used.

A problem of generic grains-removing devices is that in rare cases, malfunctions can occur due to which the grains-removing members are not properly fixed in the raised neutral position and move unintentionally into the lowered grains-removing position. When, for example, the chopping machine then rotates and when the grains-removing members together with the chopping machine are pulled through the cake of spent grains, the entire filter layer of the cake of spent grains is destroyed, and only poor wort quality is achieved.

In order to be at least able to recognize this malfunction to initiate then appropriate corrective measures, DE 102 33 513 proposes a position sensor, by means of which the position of the grains-removing member can be detected. The disadvantage of the known position sensor is that the same must be wired to ensure, on the one hand, the energy supply to the sensor and, on the other hand, to transmit the sensor signals from the position sensor to the superordinated control unit. However, due to the necessary arrangement of the position sensor close to the grains-removing member, the wiring of the position sensor requires a high installation complexity. Moreover, the known wiring systems are proven to be fault-prone since in the interior of the lauter tun, high temperatures and a disadvantageous steam atmosphere exist.

Based on this prior art, it is hence the object of the present invention to propose a new grains-removing device with a position sensor system for the grains-removing members that has a high reliability and can be installed cost-efficiently.

This object is achieved by a grains-removing device according to the teaching of claim 1.

Advantageous embodiments of the invention are the subject matter of the sub-claims.

The fundamental idea of the invention is that for the installation of the position sensor, no wiring whatsoever has to be installed. To achieve this, according to the invention the position sensor is equipped or connected, respectively, with a transmitter unit so that the sensor data of the position sensor for the description of the position of the grains-removing member can be transmitted in a wireless manner from the transmitter unit to a stationary mounted receiver unit. From the receiver unit, on the other hand, the sensor data can be transferred by means of conventional technology to the superordinated control unit. According to the second aspect of the grains-removing device according to the invention, for supplying electrical energy to the transmitter unit, an electromechanical generator unit is provided, by means of which mechanical drive movements can be transformed into electrical supply power. The generator unit is installed here in such a manner that the adjusting movements of the grains-removing device are transmitted by means of a transmission device as drive movements to the generator unit so that in the generator unit, electrical energy can be generated from the drive movement for the supply to the transmitter unit. As a result, hence, the position sensor is completely self-sufficient and can be installed without wiring to the grains-removing device eventually in any position. Laying of data cables or electrical supply lines, respectively, is completely eliminated.

In which location the position sensor is installed is basically by choice. The position sensor according to the invention offers particularly significant advantages when it is mounted together with the grains-removing device to a rotationally drivable lauter tun chopping unit, since the laying of cables in such grains-removing devices for the supply to the position sensor or for the data transfer, respectively, to the superordinated control unit is very complex.

The type of generator unit for transforming the mechanical adjusting movement into electrical energy is basically by choice. Piezo elements work particularly reliably and effectively. In these piezo elements, the piezo-electric effect is utilized to transform mechanical energy into electrical energy.

The construction of the transmission device again is by choice. The transmission of the adjusting movement to the generator unit can be realized in a particularly simple and reliable manner when, for this purpose a drive cam is provided that is adjusted during the adjustment of the grains-removing device. With this drive cam, a tappet can be engaged which, in turn, transmits the adjusting movement of the drive cam to the piezo element.

The arrangement of the receiver unit for receiving the sensor data from the transmitter unit is basically by choice as well. In order not to be required to protect the receiver unit against the high temperatures or the steam, respectively, in the lauter tun, it is particularly advantageous when the receiver unit is arranged outside of the lauter tun.

The type of the receiver unit is by choice as long as a sufficient data transfer is allowed. According to a preferred embodiment, the receiver unit is designed in the form of a mobile radio antenna. In particular, rod antennas are suitable for the data transfer of sensor data. If the lauter tun is provided with a sight glass, a manhole cover, or a cover glass of a lighting device, the receiver unit can also be mounted to the respective components within or on the lauter tun.

A particularly simple mounting of the receiver unit arises when the same is designed in the form of an adhesive antenna or a throw-out antenna.

To obtain a complete overview over the position of the grains-removing members within the lauter tun, the position sensor has to be able to detect the arrangement of the grains-removing members in the neutral position as well as the arrangement of the grains-removing members in the grains-removing position.

In many cases, a plurality of grains-removing members is provided on the grains-removing device, wherein each individual grains-removing member can cause a disturbance of the cake of spent grains. Accordingly, when using a plurality of grains-removing members, it is advantageous when a position sensor for position monitoring is provided on each grains-removing member.

The manner in which the sensor data of the position sensor are processed is basically by choice. According to a first preferred embodiment, a display device is provided which is controlled with the sensor data of the position sensor. In this manner, at least a certain positioning of the grains-removing member can be signalized on the display device.

In addition to that, the sensor data can also be transmitted to a fault display to signalize false positions of the grains-removing member.

Alternatively or in addition, respectively, to the simple signalizing of the position of the grains-removing member or a false position of the grains-removing member, respectively, the sensor data of the position sensor can also be evaluated in the control unit of the lauter tun, and the evaluation results can be used for the controlling or regulating, respectively, of lauter processes.

An embodiment of the invention is schematically illustrated in the drawings and is explained hereinafter by way of example.

In the figures:

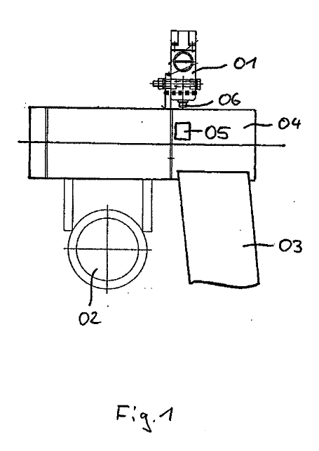

FIG. 1 shows a position sensor arranged on a chopping unit beam in a side view;

FIG. 2 shows the position sensor according to FIG. 1 with an arrangement of the grains-removing member in the neutral position in a front view;

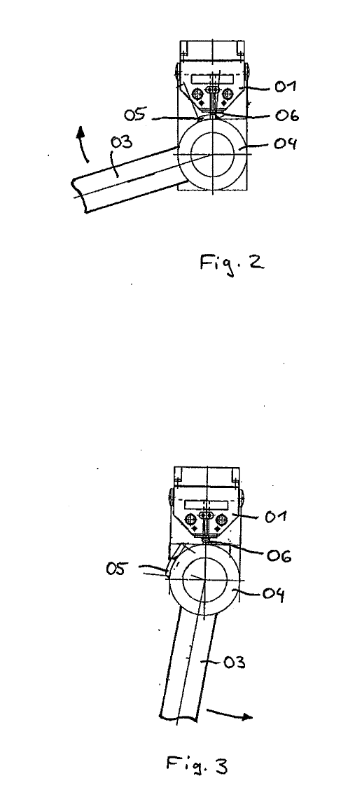

FIG. 3 shows the position sensor according to FIG. 2 with an arrangement of the grains-removing member in the grains-removing position.

FIG. 1 shows a position sensor 01 that is arranged on a chopping unit beam 02 within a lauter tun. The position sensor 01 serves for detecting the position of a grains-removing member (not shown here), which is flexibly mounted to the chopping unit beam 02 by means of a joint arm 03 and a joint sleeve 04. On the outer side of the joint sleeve 04, a drive cam 05 is arranged which is pivoted with the joint sleeve 04 and hence provides information about the grains-removing members which are mounted to the lower side (not shown here) of the joint arm 03.

FIG. 2 shows the position sensor 01 with the grains-removing member (not shown here) arranged in the neutral position. For this, the joint arm 03 is lifted so that the joint sleeve 04 is pivoted clockwise, and the drive cam 05 pushes a tappet 06 within the position sensor 01 upwards. By means of this adjusting movement of the tappet 06, a piezo element is actuated within the position sensor 01 to generate a small amount of electrical energy. With this electrical power, a transmitter unit is then operated by means of which the adjustment of the grains-removing member detected by the position sensor 01 is transmitted to a receiver unit (not shown here).

As shown in FIG. 3, the drive cam 05 is disengaged again from the tappet 06 while the joint arm 03 is pivoting downwards, and by means of this adjustment movement, in turn, a short electrical pulse is generated with a piezo element. Also this adjustment can then be transmitted in a wireless manner to a receiver unit (not shown here).

1. A grains-removing device for a lauter tun, comprising: at least one grains-removing member adjustable between a raised neutral position and a lowered grains-removing position, the grains removing member configured to convey the spent grains out of the lauter tun by rotationally driving the grains-removing member when arranged in the lowered grains-removing position; at least one position sensor configured to detect the position of the grains-removing member in at least one position and to generate sensor data describing the position of the at least one grains-removing member; a transmitter unit in communication with the position sensor, a control unit; an electro-mechanical generator unit; and a transmission device; wherein the transmitter unit is configured to wirelessly transmit the sensor data describing the position of the grains-removing member to a stationary mounted receiver unit; configured to transmit the sensor data to the control unit; wherein the electromechanical generator unit supplies electrical energy to the transmitter unit, and wherein the transmission device is configured to transmit adjusting movements of the grains-removing device as drive movements directly or indirectly to the generator unit and the generator unit generates electrical energy from the drive movement.

2. The grains-removing device according to claim 1, wherein the position sensor and the grains-removing device are mounted to a rotationally drivable lauter tun chopping unit.

3. The grains-removing device according to claim 1, wherein the generator unit comprises a piezo element for transforming the mechanical drive movements into electrical supply power.

4. The grains-removing device according to claim 1, wherein the transmission device comprises a drive cam which is moved during the adjustment of the grains-removing device, wherein the drive cam is engaged with a tappet which transmits the adjusting movement of the drive cam to the piezo element.

5. The grains-removing device according to claim 1, wherein the receiver unit is arranged outside of the lauter tun.

6. The grains-removing device according to claim 1, wherein the receiver unit is designed in the form of a mobile radio antenna, in particular in the form of a rod antenna.

7. The grains-removing device according to claim 1, wherein the receiver unit is arranged on a sight glass of the lauter tun, on a manhole cover of the lauter tun, or on a cover glass of a lighting device of the lauter tun.

8. The grains-removing device according to claim 1, wherein the receiver unit is designed in the form of an adhesive antenna or a throw-out antenna.

9. The grains-removing device according to claim 1, wherein the position sensor is configured to detect the arrangement of the grains-removing member in the neutral position and/or the arrangement of the grains-removing member in the grains-removing position.

10. The grains-removing device according to claim 1, wherein the grains-removing device is provided with a plurality of grains-removing members and each grains-removing member is provided with a position sensor.

11. The grains-removing device according to claim 1, further comprising a display device controlled and configured to signalize certain positions of the grains-removing member based on sensor data.

12. The grains-removing device according to claim 1, wherein a fault display is controlled in such a manner that on the fault display, a false position of the grains-removing member based on sensor data is signalized.

13. The grains-removing device according to claim 1, wherein the control unit of the lauter tun is configured to query the position of the grains-removing member and to control or regulate the processes within the lauter tun accordingly based on the sensor data transferred from the position sensor to the control unit of the lauter tun.
